(19) United States
(12) Patent Application Publication
(10) Pub. No.: US 2025/0087927 A1
(43) Pub. Date: Mar. 13, 2025

(54) Connector and Connector Assembly

(71) Applicant: Tyco Electronics (Shanghai) Co., Ltd., Shanghai (CN)

(72) Inventors: Jiaoyong (Mac) Liu, Shanghai (CN); Wei Yao, Kunshan (CN)

(73) Assignee: Tyco Electronics (Shanghai) Co., Ltd., Shanghai (CN)

(21) Appl. No.: 18/883,422

(22) Filed: Sep. 12, 2024

(30) Foreign Application Priority Data
Sep. 12, 2023 (CN) 202311175788.5

(51) Int. Cl. H01R 13/502; H01R 13/05; H01R 13/11; H01R 13/42

(52) U.S. Cl. CPC H01R 13/502; H01R 13/055; H01R 13/113; H01R 13/42

(57) ABSTRACT

A connector includes an insulation housing, a pair of terminal modules, and an insulation component. The pair of terminal modules are installed side by side in the insulation housing. Each terminal module includes a shell having a first side wall and an opposite second side wall, a first terminal having a rear part installed in the shell, a connection member rotatably connecting the first terminal to the shell, and a second terminal having a front part inserted between the first terminal and the second side wall of the shell. The insulation component is movably arranged in the insulation housing, and is clamped between the second terminals of the pair of terminal modules.

### CROSS-REFERENCE TO RELATED APPLICATION

This application claims the benefit of Chinese Patent Application No. CN202311175788.5 filed on Sep. 12, 2023 in the State Intellectual Property Office of China, the whole disclosure of which is incorporated herein by reference.

### FIELD OF THE DISCLOSURE

The present disclosure relates to a connector and a connector assembly including the connector.

### BACKGROUND OF THE INVENTION

In the prior art, a power supply unit of a data center is electrically connected to the metal bars of the cabinet through connectors. In order to improve the current transmission capacity of the connector, the terminals of the connector usually adopt multi-layer interleaved overlapping terminals. That is, the terminals include multiple stacked terminal pieces. Each terminal piece is not only used for transmitting current, but also has an elastic structure for providing elastic contact force. This makes the structure of the terminal piece complex, difficult to manufacture, and can also lead to excessive insertion force when inserting the mating terminal. Typically, the insertion force of the mating terminal is proportional to the third power of the thickness of the connector terminal.

In the prior art, there are situations of offset mating and tilt mating between the mating terminal and the connector terminal. However, the floating contact performance of existing connector is poor. In the situations of offset mating and tilt mating, one side of the terminal is subjected to a large force, while the other side is subjected to a small force, even without contact. Especially in extreme offset mating or extreme tilt mating, this problem is more serious, significantly affecting product performance, leading to high and unstable contact impedance of connector product, and reducing the current carrying capacity of connector product.

### SUMMARY OF THE INVENTION

According to an embodiment of the present disclosure, a connector includes an insulation housing, a pair of terminal modules and an insulation component. The pair of terminal modules are installed side by side in the insulation housing. Each terminal module includes a shell having a first side wall and an opposite second side wall, a first terminal having a rear part installed in the shell, a connection member rotatably connecting the first terminal to the shell, and a second terminal having a front part inserted between the first terminal and the second side wall of the shell. The insulation component is movably provided in the insulation housing, and is clamped between the second terminals of the pair of terminal modules.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector according to an exemplary embodiment of the present invention;

FIG. 2 shows a three-dimensional sectional view of a connector according to an exemplary embodiment of the present invention;

FIG. 3 shows an illustrative exploded view of a connector according to an exemplary embodiment of the present invention;

FIG. 4 shows a planar sectional view of a connector according to an exemplary embodiment of the present invention;

FIG. 5 shows an illustrative view of a connector and a mating plug in accordance with an exemplary embodiment of the present invention;

FIG. 6 shows an illustrative perspective view of a terminal module of a connector according to an exemplary embodiment of the present invention;

FIG. 7 shows a three-dimensional sectional view of a terminal module of a connector according to an exemplary embodiment of the present invention;

FIG. 8 shows an exploded schematic diagram of a terminal module of a connector according to an exemplary embodiment of the present invention;

FIG. 9 shows an illustrative perspective view of the first terminal of a terminal module of a connector according to an exemplary embodiment of the present invention; and

FIG. 10 shows an illustrative perspective view of the housing of a terminal module of a connector according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector is provided. The connector includes an insulation housing, and a pair of terminal modules installed side by side in the insulation housing. The terminal module comprises: 1) a shell having an opposite first side wall and second side wall; 2) a terminal having a rear part installed in the shell; 3) a connection member rotatably connecting the first terminal to the shell; 4) and a second terminal having a front part inserted between the first terminal and the second side wall of the shell. The connector further includes an insulation component movably provided in the insulation housing. The insulation component is clamped between the second terminals of the pair of terminal modules.

According to another general embodiment of the present disclosure, a connector assembly is provided. The connector assembly comprises the above connector, and a mating plug or connector inserted between the pair of first terminals of the connector to make electrical contact with the pair of first terminals.

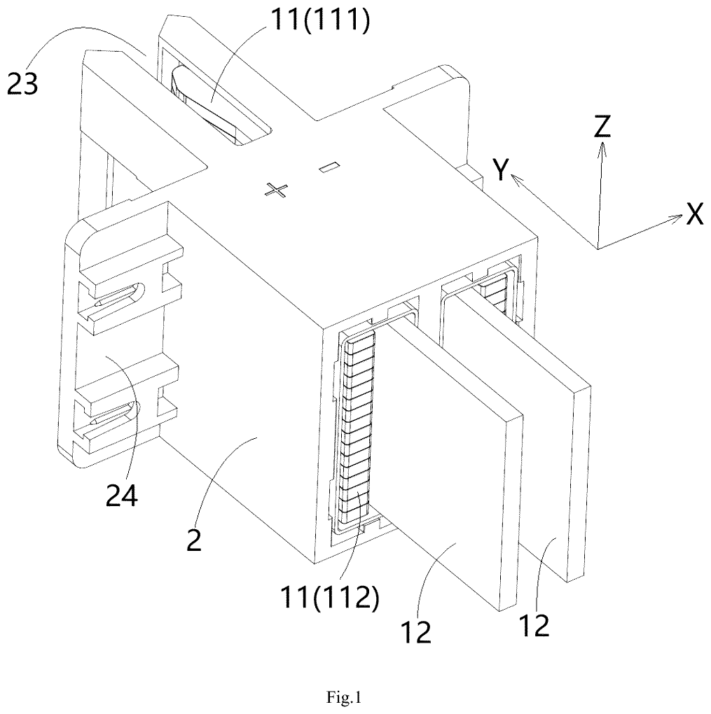

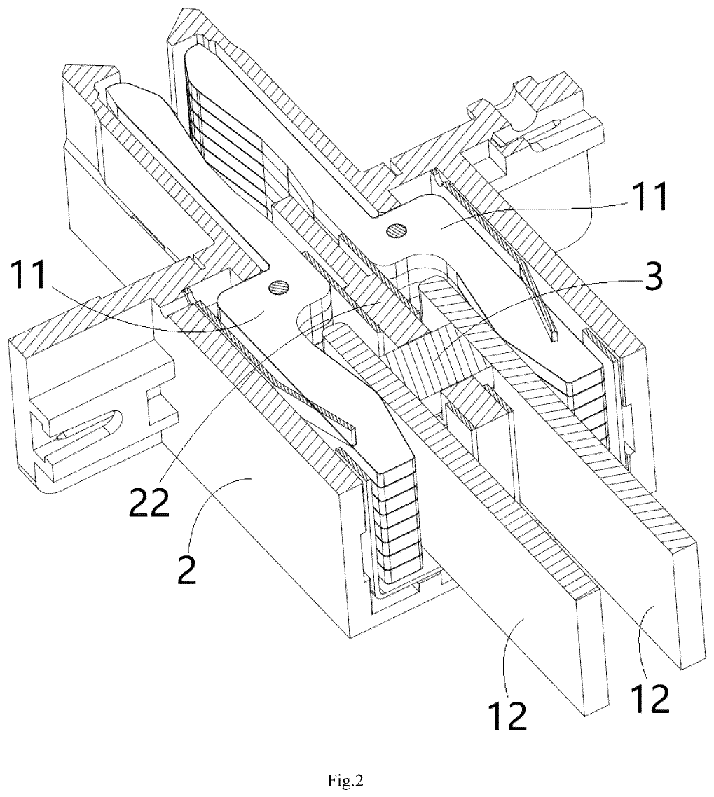

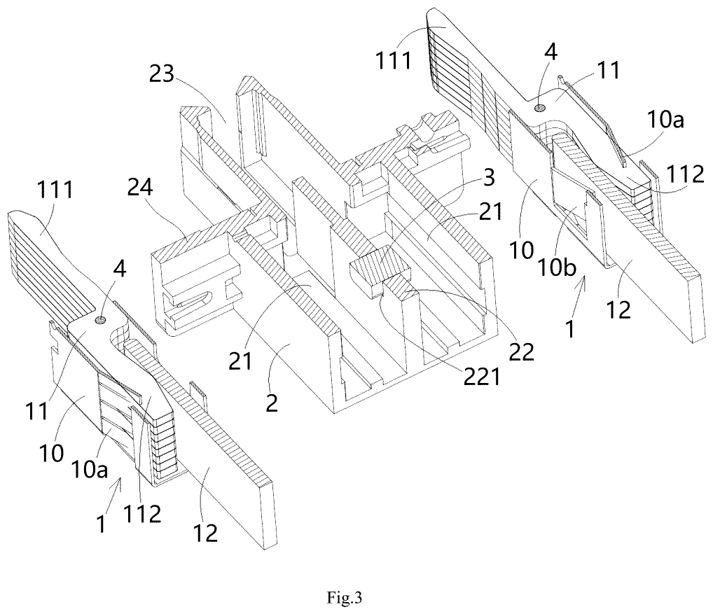

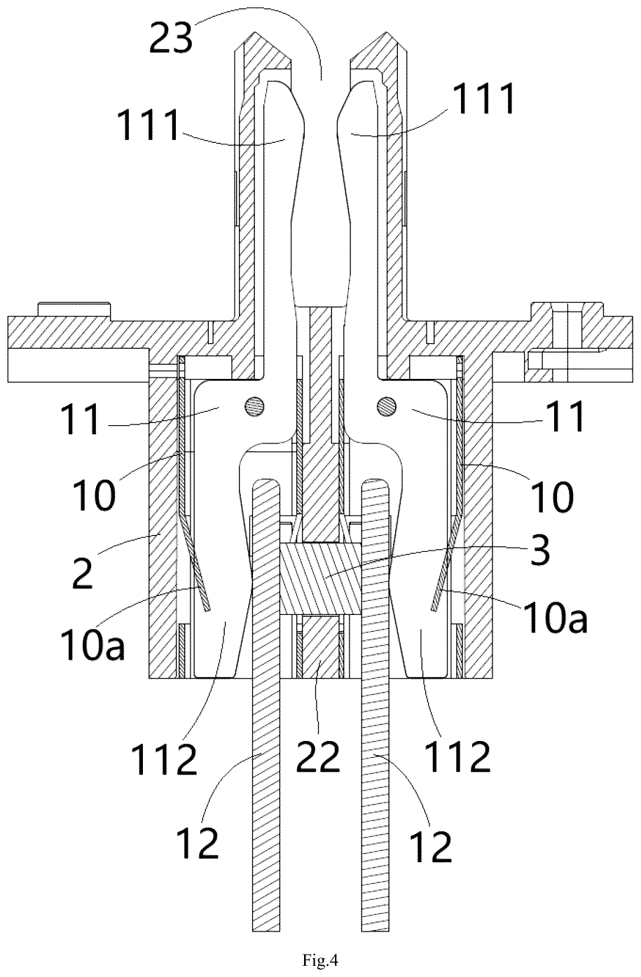

FIG. 1 shows an illustrative perspective view of a connector according to an exemplary embodiment of the present disclosure. FIG. 2 shows a three-dimensional sectional view of a connector according to an exemplary embodiment of the present disclosure. FIG. 3 shows an illustrative exploded view of a connector according to an exemplary embodiment of the present disclosure. FIG. 4 shows a planar sectional view of a connector according to an exemplary embodiment of the present disclosure.

As shown in FIGS. 1-4, in an exemplary embodiment of the present disclosure, a connector is provided. The connector includes an insulation housing 2 and a pair of terminal modules 1. The pair of terminal modules 1 are installed side by side in the insulation housing 2.

The terminal module 1 includes a shell 10, a first terminal 11, a connection member 4 and a second terminal 12. The shell 10 has a first side wall 101 and a second side wall 102 opposite to the first side wall 101. The rear part of the first terminal 11 is installed in the shell 10. The connection member 4 rotatably connects the first terminal 11 to shell 10. The front part of the second terminal 12 is inserted between the first terminal 11 and the second side wall 102 of the shell 10.

A first elastic arm 10a and a second elastic arm 10b are formed on the first side wall 101 and the second side wall 102 of the shell 10, respectively. The first elastic arm 10a and the second elastic arm 10b are pressed onto the first terminal 11 and the second terminal 12, respectively. The connector also includes an insulation component 3 movable and located in the insulation housing 2. The insulation component 3 is clamped between the second terminals 12 of the pair of terminal modules 1.

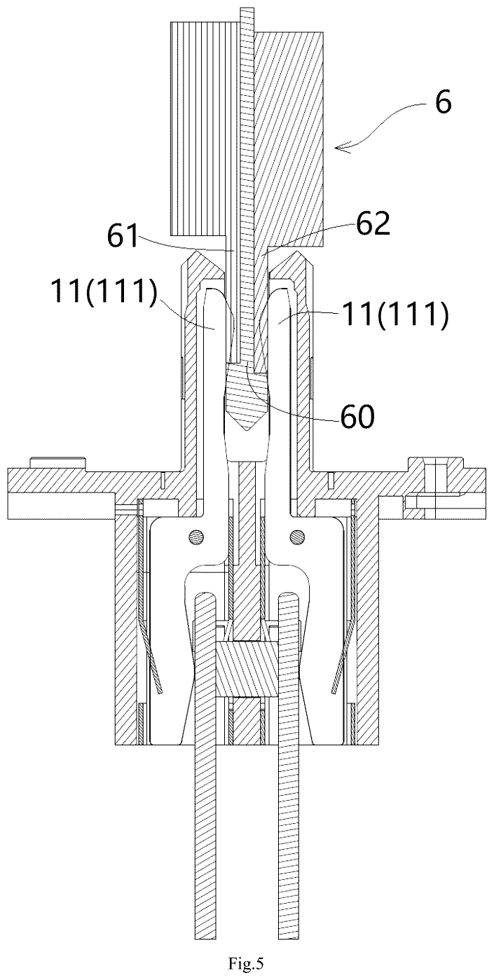

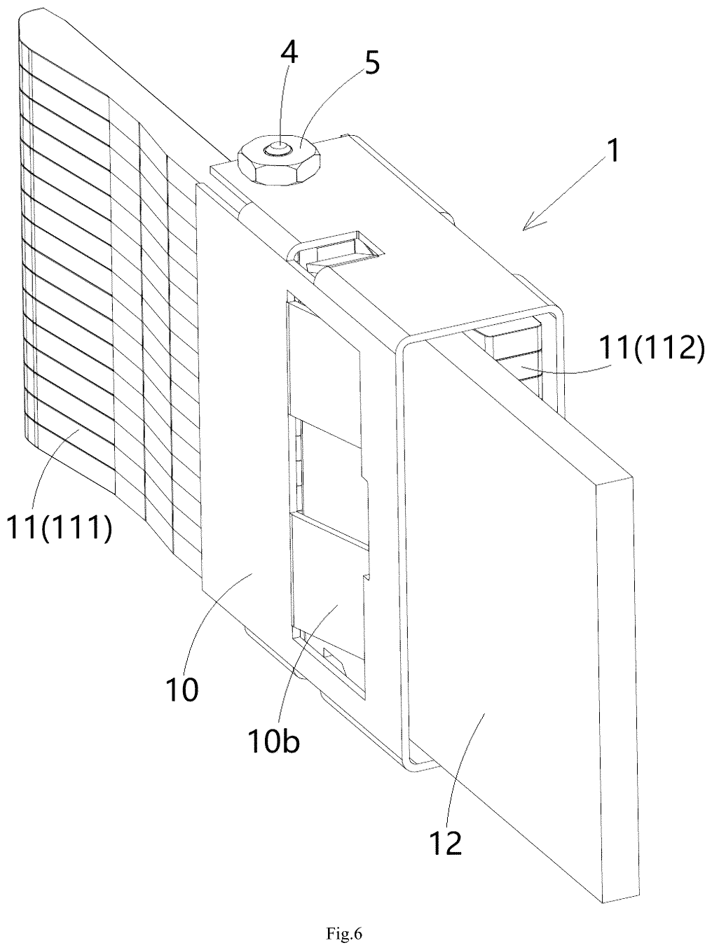

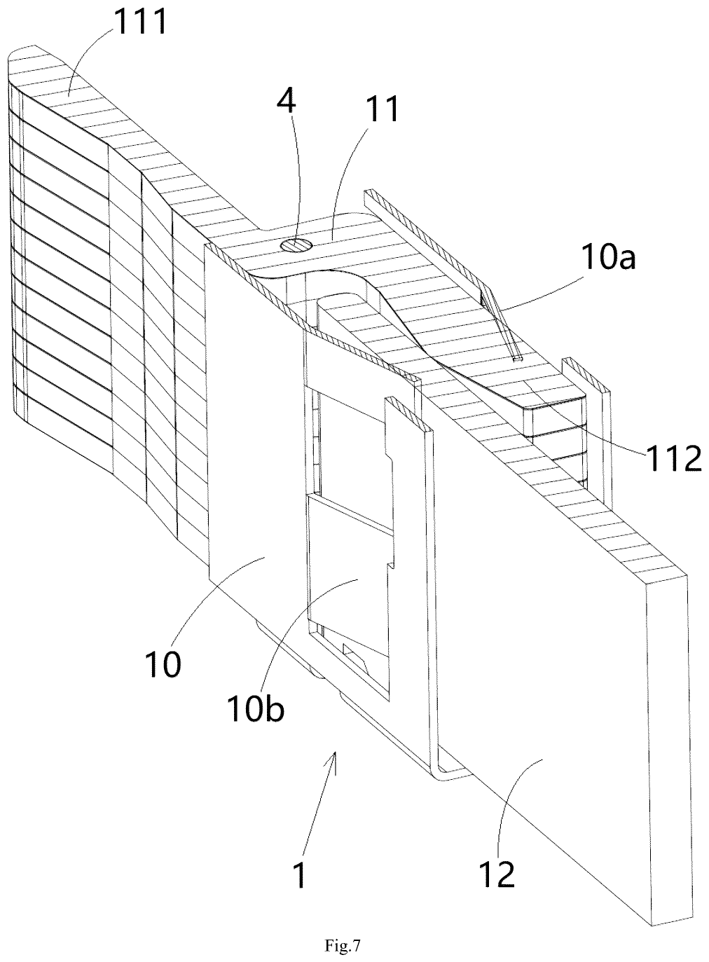

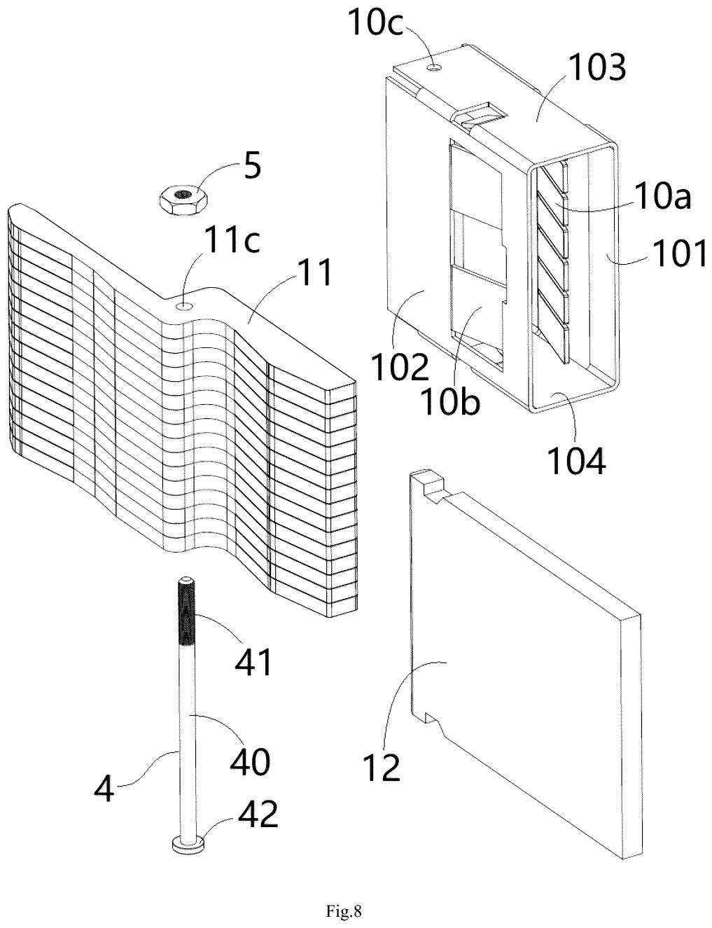

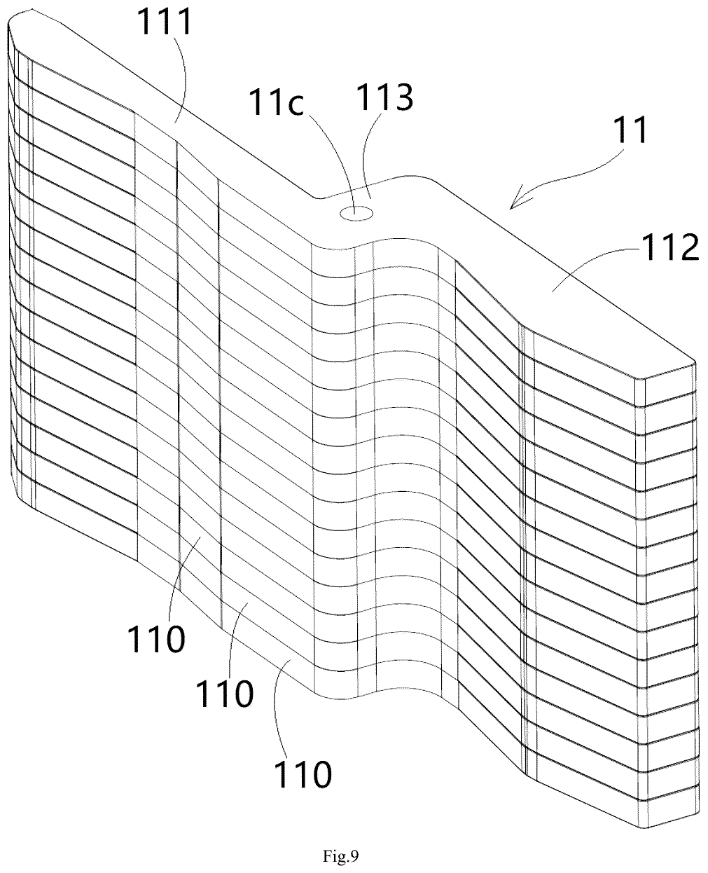

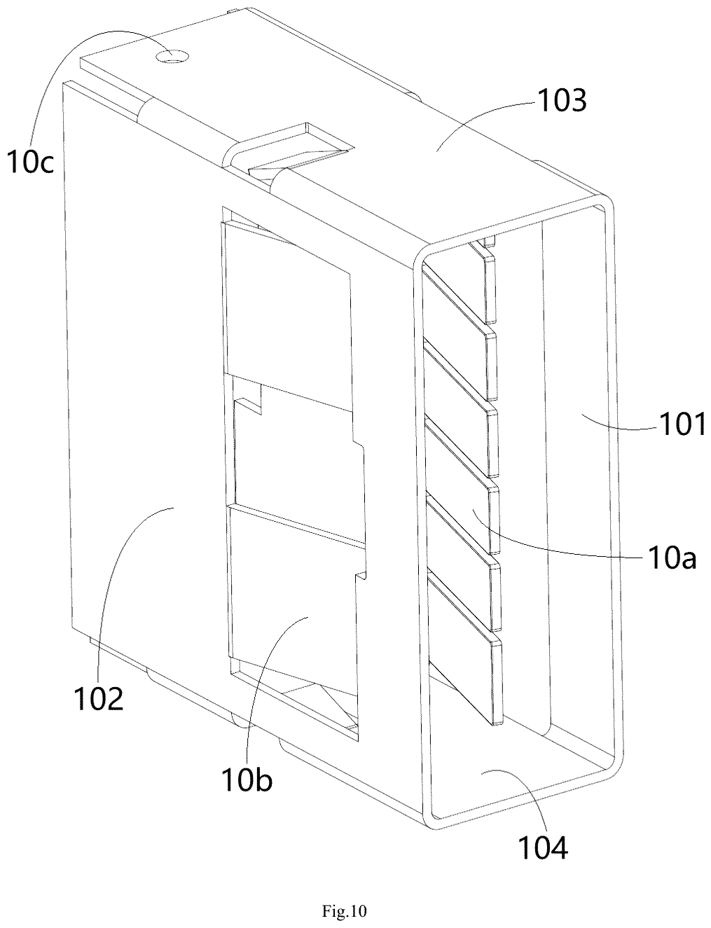

FIG. 5 shows an illustrative view of a connector and a mating plug 6 in accordance with an exemplary embodiment of the present disclosure. FIG. 6 shows an illustrative perspective view of terminal module 1 of a connector according to an exemplary embodiment of the present disclosure. FIG. 7 shows a three-dimensional sectional view of terminal module 1 of a connector according to an exemplary embodiment of the present disclosure. FIG. 8 shows an exploded schematic diagram of terminal module 1 of a connector according to an exemplary embodiment of the present disclosure. FIG. 9 shows an illustrative perspective view of the first terminal 11 of the terminal module 1 of a connector according to an exemplary embodiment of the present disclosure. FIG. 10 shows an illustrative perspective view of the shell 10 of the terminal module 1 of a connector according to an exemplary embodiment of the present disclosure.

As shown in FIGS. 1-10, in the illustrated embodiments, the insulation component 3 balances the contact force between the pair of first terminals 11 to ensure that the pair of first terminals 11 can make stable and reliable electrical contact with the mating plug 6. Therefore, the present disclosure can reduce the contact impedance of the first terminal during offset mating and tilt mating, and improve the current carrying capacity of the first terminal during offset mating and tilt mating. The first terminal can also make stable and reliable electrical contact with the mating plug during offset mating and tilt mating, greatly improving the electrical connection performance of the connector.

A pair of accommodation chambers 21 are formed in the insulation housing 2. The pair of accommodation chambers 21 are arranged side by side in the transverse direction X of the insulation housing 2. The pair of terminal modules 1 are respectively installed in the pair of accommodation chambers 21 of the insulation housing 2.

In the illustrated embodiments, the insulation housing 2 has a partition wall 22 that separates the pair of accommodation chambers 21 from each other. A through hole 221 is formed in the partition wall 22 that allows the insulation component 3 to pass through. The insulation component 3 is installed in the through hole 221 of the partition wall 22 and can move along the transverse direction X relative to the partition wall 22. The insulation component 3 has opposite ends in the transverse direction X. The two ends of the insulation component 3 respectively pass through the second side walls 102 of the pair of shells 10 and are respectively pressed against the pair of second terminals 12.

The first terminal 11 has opposite front and rear parts in the longitudinal direction Y of the insulation housing 2. The rear part of the first terminal 11 is accommodated in the shell 10. The front part of the first terminal 11 extends from the shell 10. The insulation housing 2 also has a slot 23 located in front of and communicated with the pair of accommodation chambers 21. The front parts of the pair of first terminals 11 are accommodated in the slot 23 for clamping the mating plug 6 inserted into the slot 23 to make electrical contact with the mating plug 6.

The second terminal 12 has front and rear parts opposite to each other in the longitudinal direction Y of the insulation housing 2. The front part of the second terminal 12 is accommodated in the shell 10. The rear part of the second terminal 12 extends from the shell 10 and the insulation housing 2 for electrical connection with a cable, a busbar, or a mating terminal.

The first terminal 11 comprises multiple terminal pieces 110 stacked in the height direction Z of the shell 10. A through-hole 11c is formed in the terminal piece 110 that allows the connection member 4 to pass through. The number and thickness of terminal pieces 110 in the first terminal 11 are determined based on the magnitude of the current that the connector needs to transmit. A number of terminal pieces 110 in the first terminal 11 is not less than 3.

The shell 10 has a first side wall 101 and a second side wall 102 opposite to each other in its transverse direction X, as well as a top wall 103 and a bottom wall 104 opposite to each other in its height direction Z. There are connection holes 10c respectively formed in the top wall 103 and bottom wall 104 of the shell 10 that allow the connection member 4 to pass through. The inner diameter of the connection hole 10c is greater than the diameter of the connection member 4 to allow the connection member 4 to move relative to the shell 10.

The connection member 4 comprises a rotatable shaft portion 40 with smooth surface. The rotatable shaft portion 40 passes through the through-hole 11c in the first terminal 11 along the height direction Z. This allows the first terminal 11 to rotate around the axis of the rotatable shaft portion 40.

The connection member 4 further comprises a threaded part 41 and a head 42 located at both ends of the shaft portion 40, respectively. The connector further comprises a nut 5 for connecting to the threaded part 41 of the connection member 4. The head 42 of connection member 4 is positioned on one of the top wall 103 and bottom wall 104 of shell 10. The threaded part 41 of connection member 4 passes through the other of the top wall 103 and bottom wall 104 of shell 10 and is threaded to the nut 5.

The terminal piece 110 comprises a front arm 111, a rear arm 112 and a bending part 113. The front arm 111 extends along the longitudinal direction of the shell 10. The rear arm 112 extends along the longitudinal direction of the shell 10. The bending part 113 is connected between the rear end of the front arm 111 and the front end of the rear arm 112. The bending part 113 is bent 90 degrees relative to the front arm 111 and the rear arm 112, resulting in a Z-shaped terminal piece 110 as a whole. The through-hole 11c is formed in the bending part 113 of the terminal piece 110 and runs through the terminal piece 110 along the thickness direction of the terminal piece 110.

The second terminal 12 is in a flat shape. The front part of the second terminal 12 is clamped between an elastic arm 10b of the shell 10 and the rear arm 112 of the first terminal 11. The rear arms 112 of the first pair of terminals 11 are adapted to clamp the mating plug 6 inserted between them to make electrical contact with the mating plug 6.

The shell 10 is an integral metal stamped component. The pair of shells 10 of the connector are electrically isolated from each other by the partition wall 22 of the insulation housing 2, electrically isolating the pair of terminal modules 1 from each other.

The first terminal 11 and the second terminal 12 are rigid conductive components used for transmitting current. The contact force between the first terminal 11 and the mating plug 6, as well as the contact force between the first terminal 11 and the second terminal 12, are provided by the first elastic arm 10a and the second elastic arm 10b on the shell 10.

Still referring to FIGS. 1-10, in another exemplary embodiment of the present disclosure, a connector assembly is also disclosed. The connector assembly includes the aforementioned connector and a mating plug 6. The mating plug 6 is inserted between the pair of first terminals 11 of the connector to make electrical contact with the pair of first terminals 11.

The mating plug 6 comprises an insulation substrate 60, a first conductive pad 61 and a second conductive pad 62. The insulation substrate 60 has opposite sides in its thickness direction. The first conductive pad 61 is formed on one side of the insulation substrate 60. The second conductive pad 62 is formed on the other side of the insulation substrate 60. The pair of first terminals 11 of the connector are in electrical contact with the first conductive pad 61 and the second conductive pad 62 of the mating plug 6, respectively. The pair of first terminals 11 of the connector are electrically isolated from each other and used to connect to the positive and negative terminals of a power supply, respectively.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
an insulation housing;
a pair of terminal modules installed side by side in the insulation housing, each terminal module including:
a shell having a first side wall and an opposite second side wall;
a first terminal having a rear part installed in the shell;
a connection member rotatably connecting the first terminal to the shell; and
a second terminal having a front part inserted between the first terminal and the second side wall of the shell; and
an insulation component movably arranged in the insulation housing, the insulation component clamped between the second terminals of the pair of terminal modules.

2. The connector according to claim 1, wherein:
a pair of accommodation chambers are formed in the insulation housing and arranged side by side in a transverse direction of the insulation housing; and
the pair of terminal modules are respectively installed in the pair of accommodation chambers of the insulation housing.

3. The connector according to claim 2, wherein:
the insulation housing includes a partition wall separating the pair of accommodation chambers from each other, the partition wall including a through hole; and
the insulation component is installed in the through hole of the partition wall and is moveable relative to the partition wall in the transverse direction.

4. The connector according to claim 3, wherein the insulation component has two opposite ends in the transverse direction, the two ends of the insulation component respectively pass through the second side walls of the pair of shells and are respectively pressed against the pair of second terminals.

5. The connector according to claim 2, wherein:
the first terminal has opposite front and rear parts in a longitudinal direction of the insulation housing, the rear part of the first terminal is accommodated in the shell, and the front part of the first terminal extends out of the shell;
the insulation housing includes a slot located in front of and communicated with the pair of accommodation chambers; and
the front parts of the pair of first terminals are arranged in the slot for clamping a mating plug inserted into the slot to make electrical contact with the mating plug.

6. The connector according to claim 2, wherein the second terminal has opposite front and rear parts in a longitudinal direction of the insulation housing, the front part of the second terminal is accommodated in the shell, and the rear part of the second terminal extends out of the shell and the insulation housing for electrical connection with a cable, a busbar or a mating terminal.

7. The connector according to claim 1, wherein the first terminal includes multiple terminal pieces stacked in a height direction of the shell, and a through-hole is formed in the terminal piece that allows the connection member to pass through.

8. The connector according to claim 7, wherein the number and thickness of terminal pieces in the first terminal are determined according to the magnitude of the current that the connector needs to transmit.

9. The connector according to claim 8, wherein the number of terminal pieces in the first terminal is not less than 3.

10. The connector according to claim 9, wherein:
the shell has a first side wall and a second side wall opposite to each other in its transverse direction, as well as a top wall and a bottom wall opposite to each other in its height direction; and
a connection hole is formed in each of the top wall and bottom wall of the shell to allow the connection member to pass through, and an inner diameter of the connection hole is larger than a diameter of the connection member to allow the connection member to move relative to the shell.

11. The connector according to claim 10, wherein the connection member includes a rotatable shaft portion with smooth surface, the rotatable shaft portion passes through the through-hole in the first terminal along the height direction allowing the first terminal to rotate around the axis of the rotatable shaft portion.

12. The connector according to claim 11, wherein:
the connection member further includes a threaded part and a head respectively located at both ends of the rotatable shaft portion, and the connector further includes a nut for connecting to the threaded part of the connection member; and
the head of the connection member is positioned on one of the top wall and bottom wall of the shell, and the threaded part of the connection member passes through the other of the top wall and bottom wall of the shell and is threaded to the nut.

13. The connector according to claim 7, wherein the terminal piece comprises:
a front arm extending along the longitudinal direction of the shell;
a rear arm extending along the longitudinal direction of the shell; and
a bending part connected between the rear end of the front arm and the front end of the rear arm, the bending part is bent 90 degrees relative to the front arm and the rear arm, so that the terminal piece is Z-shaped.

14. The connector according to claim 13, wherein the through-hole is formed in the bending part of the terminal piece and runs through the terminal piece along a thickness direction of the terminal piece.

15. The connector according to claim 13, wherein:
the second terminal is in a flat shape, and the front part of the second terminal is clamped between an elastic arm of the shell and the rear arm of the first terminal; and
the rear arms of the first pair of terminals are adapted to clamp the mating plug inserted between them to make electrical contact with the mating plug.

16. The connector according to claim 2, wherein the shell is an integral metal stamped component, and the pair of shells of the connector are electrically isolated from each other by the partition wall of the insulation housing such that the pair of terminal modules are electrically isolated from each other.

17. The connector according to claim 1, wherein a first elastic arm and a second elastic arm are respectively formed on the first side wall and the second side wall of the shell, the first elastic arm and the second elastic arm are respectively pressed onto the first terminal and the second terminal.

18. The connector according to claim 16, wherein the first terminal and the second terminal are rigid conductive components adapted to transmit current, and a contact force between the first terminal and the mating plug and a contact force between the first terminal and the second terminal, are provided by the first elastic arm and the second elastic arm on the shell.

19. A connector assembly, comprising:
a connector, including:
an insulation housing;
a pair of terminal modules installed side by side in the insulation housing, each terminal module including:
a shell having a first side wall and an opposite second side wall;
a first terminal having a rear part installed in the shell;
a connection member rotatably connecting the first terminal to the shell; and
a second terminal having a front part inserted between the first terminal and the second side wall of the shell; and
an insulation component movably provided in the insulation housing, the insulation component clamped between the second terminals of the pair of terminal modules; and
a mating plug inserted between the pair of first terminals of the connector to make electrical contact with the pair of first terminals.

20. The connector assembly according to claim 19, wherein the mating plug comprises:
an insulation substrate with opposite sides in its thickness direction;
a first conductive pad formed on one side of the insulation substrate; and
a second conductive pad formed on another side of the insulation substrate, the pair of first terminals of the connector are in electrical contact with the first conductive pad and the second conductive pad of the mating plug, respectively.
